(19) United States
(12) Patent Application Publication
(10) Pub. No.: US 2022/0347524 A1
(43) Pub. Date: Nov. 3, 2022

(54) MOVING BIKE DEVICE CONTROLLING CONTENTS PLAYING ACCORDING TO CONTENTS PROPERTIES AND DRIVING METHOD THEREOF

(71) Applicant: PJB Co.,ltd, Seongnam-si (KR)

(72) Inventors: Yong-Ho Kim, Seongnam-si (KR); Dae-Wook Park, Seongnam-si (KR); Chang-Soo Lee, Seongnam-si (KR); Woo-Jun Choi, Seongnam-si (KR)

(21) Appl. No.: 17/365,123

(22) Filed: Jul. 1, 2021

(30) Foreign Application Priority Data
Apr. 28, 2021 (KR) 10-2021-0055159

(51) Int. Cl. A63B 24/00; A63B 22/06; A63B 21/005; A63B 71/06; A63B 21/00

(52) U.S. Cl. CPC A63B 24/0087; A63B 22/0605; A63B 21/0056; A63B 71/0622; A63B 21/154; A63B 2024/009; A63B 2230/01; A63B 2071/0644; A63B 2225/20

(57) ABSTRACT

An embodiment of the present invention provides a moving bike device including: a memory configured to store distance information and altitude information; a content implementation unit configured to adjust a reproduction state of content in response to a speed of a wheel depending on pedaling of a user; a controller configured to calculate a road slope from the distance information and the altitude information, and to calculate a travel distance depending on the pedaling of the user; and a road slope implementation unit configured to adjust strength of a brake in proportion to the road slope corresponding to the travel distance.

### CROSS-REFERENCE TO RELATED APPLICATION

This application claims priority to and benefits of Korean Patent Application No. 10-2021-0055159, filed in the Korean Intellectual Property Office on Apr. 28, 2021, the entire contents of which are incorporated herein by reference.

### BACKGROUND

### (a) Field

The embodiment of the present invention relates to a moving bike device and its driving method, and more particularly, to a moving bike device and a driving method thereof for controlling content reproduction according to a content attribute by pedaling of a bike.

### (b) Description of the Related Art

There are numerous exercise facilities and equipment for physical activity and exercise, but busy modern people absolutely lack an amount of daily physical activity due to convenience of life. In addition, outdoor exercise is restricted by influences of fine dust, air pollution, and ultraviolet rays.

Exercise using a cycle machine, which is a representative means of indoor exercise, has a very good effect on a body, but because there is no movement of a whole body, boredom may be easily felt. It is difficult for people to overcome boredom, and it is easy to give up exercise in the middle.

The above information disclosed in this Background section is only for enhancement of understanding of the background of the invention, and therefore, it may contain information that does not form the prior art that is already known in this country to a person of ordinary skill in the art.

### SUMMARY

The embodiment of the present invention has been made in an effort to provide a moving bike device and a driving method thereof, which can provide a feeling of immersion and motivation to a user.

An embodiment of the present invention provides a moving bike device including: a memory configured to store distance information and altitude information; a content implementation unit configured to adjust a reproduction state of content in response to a speed of a wheel depending on pedaling of a user; a controller configured to calculate a road slope from the distance information and the altitude information, and to calculate a travel distance depending on the pedaling of the user; and a road slope implementation unit configured to adjust strength of a brake in proportion to the road slope corresponding to the travel distance.

The road slope implementation unit may include: a magnet unit configured to generate an eddy current in the wheel as it is positioned adjacent to the wheel; and a magnet driver configured to move the magnet unit closer to the wheel in proportion to the road slope, and the strength of the brake may be adjusted in proportion to a magnitude of the eddy current.

The distance information and the altitude information may be synchronized with a natural real image.

It may further include a road surface condition implementation unit configured to change a phase of a saddle depending on a road surface condition based on a vibration that is synchronized to the natural real image.

The road surface condition implementation unit may include: a shaft connected to the saddle; a pulley connected to the shaft; a motor configured to move the pulley in a forward or backward direction; and a motor driver configured to drive the motor depending on the road surface condition.

It may further include a subscriber authentication unit configured to measure a weight of the user and to use it as a password for subscriber authentication.

Another embodiment of the present invention provides a moving bike device including: a memory configured to store content of various attributes; a content implementation unit configured to differently adjust a reproduction state of the content depending on an attribute of the content in response to a speed of a wheel according to pedaling of a user; and a display unit configured to display the content, and the content implementation unit may adjust a reproduction speed of text and images in response to the speed of the wheel depending on the pedaling of the user, may adjust a volume of a sound in response to the speed of the wheel depending on the pedaling of the user, and may adjust screen brightness or resolution of a video in response to the speed of the wheel depending on the pedaling of the user.

The content implementation unit may perform reproduction in a normal state of scrolling text when the speed of the wheel depending on the pedaling of the user is greater than or equal to a predetermined threshold, may perform reproduction such that the text is scrolled slower than the normal state when the speed of the wheel depending on the pedaling of the user is lower than the threshold, and may perform reproduction such that the text stops without being scrolled when the speed of the wheel depending on the pedaling of the user is lower than a lowest setting value.

The content implementation unit may perform reproduction in a normal state of changing an image or scrolling a webtoon when the speed of the wheel depending on the pedaling of the user is greater than or equal to a predetermined threshold, may perform reproduction such that the image is changed in an interval that is longer than the normal state or the webtoon scrolled slower than the normal state when the speed of the wheel depending on the pedaling of the user is lower than the threshold, and may perform reproduction such that the image is changed or the webtoon stops without being scrolled when the speed of the wheel depending on the pedaling of the user is lower than a lowest setting value.

The content implementation unit may reproduce the sound at a normal volume level when the speed of the wheel depending on the pedaling of the user is greater than or equal to a predetermined threshold, may reproduce the sound by reducing the volume of the sound to be lower than the normal volume level when the speed of the wheel depending on the pedaling of the user is lower than the threshold, and may stop reproducing the sound when the speed of the wheel depending on the pedaling of the user is lower than a lowest setting value.

The content implementation unit may perform reproduction in a normal state of having screen brightness or resolution of the video as original quality when the speed of the wheel depending on the pedaling of the user is greater than or equal to a predetermined threshold, may perform reproduction by reducing the screen brightness or resolution of the video to be lower than the normal state when the speed of the wheel depending on the pedaling of the user is lower than the threshold, and may stop reproducing the video when the speed of the wheel depending on the pedaling of the user is lower than a lowest setting value.

The content implementation unit may provide the user with content provided by a portal site and a content site by accessing the Internet.

It may further include a road slope implementation unit configured to adjust strength of a brake by generating an eddy current in the wheel in proportion to a road slope corresponding to a travel distance depending on the pedaling of the user.

It may further include a road surface condition implementation unit configured to change a phase of a saddle depending on a road surface condition based on a vibration that is synchronized to a natural real image.

Another embodiment of the present invention provides a driving method for a moving bike device, including: calculating a road slope from distance information and altitude information which are synchronized with a natural real image; moving a magnet unit positioned adjacent to a wheel to be closer to the wheel in proportion to the road slope; and controlling a brake depending on an eddy current generated in the wheel by the magnet unit.

It may further include adjusting a display speed of the natural real image in response to a speed of the wheel depending on pedaling of a user.

It may further include: setting a road surface condition based on a vibration synchronized to the natural real image; moving a pulley in a forward or backward direction by driving a motor depending on the road surface condition; and changing a phase of a saddle depending on a movement of the pulley.

Another embodiment of the present invention provides a driving method for a moving bike device, including: measuring a speed of a wheel depending on pedaling of a user; and reproducing content including at least one of text, an image, a sound, or a video in a normal state when the speed of the wheel is equal to or greater than a predetermined threshold, and adjusting a reproduction state of the content when the speed of the wheel is lower than the threshold.

When the speed of the wheel is lower than the threshold, reproduction may be performed such that the content is scrolled slower than the normal state, reproduction may be performed such that the image is changed in an interval that is longer than the normal state, the sound may be produced in a volume that is lower than the normal volume, and reproduction may be performed by reducing screen brightness or resolution of the video to be lower than the normal state.

When the speed of the wheel is lower than a lowest setting value, reproduction may be performed such that the text stops without being scrolled, reproduction may be performed such that the image is stopped without being changed, reproduction may be performed such that the sound stops being reproduced, and reproduction may be performed such that the video stops being reproduced.

The user may be provided with content provided by a portal site and a content site by accessing an Internet driving method.

Another embodiment of the present invention provides a driving method for a moving bike device, including: measuring a weight of a user with a scale sensor and storing the weight of the user in a memory as subscriber authentication information when the user sits on a saddle; authenticating the subscriber by comparing a currently measured weight of the user with the subscriber authentication information stored in the memory when the user sits on the saddle; and updating the subscriber authentication information with the currently measured weight of the user.

The user may be regarded as the subscriber when the currently measured weight of the user falls within an error range based on the subscriber authentication information.

In accordance with the moving bike device and the driving method thereof according to the embodiment of the present invention, it is possible to provide a feeling of immersion to the user by giving a feeling of riding a real bike and driving outdoors in conjunction with the pedaling of the bike and it is possible to motivate the user to exercise without being bored by adjusting the display method of the content.

In general, it is difficult for aerobic exercise to exceed 30 minutes, and while content is usually viewed or played on a smartphone, the moving bike device according to the embodiment of the present invention may induce the user to exercise continuously and motivate the user to exercise without being bored by allowing the content to be scrolled or screen-transitioned through pedaling.

### BRIEF DESCRIPTION OF THE DRAWINGS

FIG. 1 illustrates a block diagram showing a moving bike device according to an embodiment of the present invention.

FIG. 2 illustrates a flowchart showing a driving method for a moving bike device according to an embodiment of the present invention.

FIG. 3 illustrates an example of an altitude of a distance stored in a memory of a moving bike device according to an embodiment of the present invention.

FIG. 4 illustrates a flowchart showing a driving method for a moving bike device according to another embodiment of the present invention.

FIG. 5 illustrates a flowchart showing a driving method for a moving bike device according to yet another embodiment of the present invention.

FIG. 6 illustrates a flowchart showing a driving method for a moving bike device according to yet another embodiment of the present invention.

### DETAILED DESCRIPTION

The embodiment of the present invention will be described more fully hereinafter with reference to the accompanying drawings, in which embodiments of the invention are shown. As those skilled in the art would realize, the described embodiments may be modified in various different ways, all without departing from the spirit or scope of the present invention.

To clearly describe the present invention, parts that are irrelevant to the description are omitted, and like numerals refer to like or similar constituent elements throughout the specification.

In addition, unless explicitly described to the contrary, the word “comprise” and variations such as “comprises” or “comprising” will be understood to imply the inclusion of stated elements but not the exclusion of any other elements.

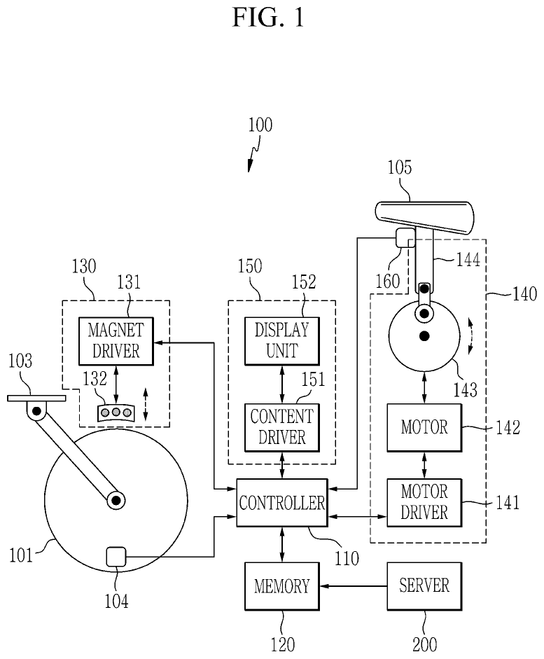

FIG. 1 illustrates a block diagram showing a moving bike device according to an embodiment of the present invention.

Referring to FIG. 1, the moving bike device 100 basically includes a wheel 101, a pedal 103, a speed sensor 104, and a saddle 105.

In addition, the moving bike device 100 includes a controller 110, a memory 120, a road slope implementation unit 130, a road surface condition implementation unit 140, a content implementation unit 150, and a subscriber authentication unit 160 to provide a feeling of immersion and motivation to a user.

The controller 110 controls the road slope implementation unit 130, the road surface condition implementation unit 140, the content implementation unit 150, and the subscriber authentication unit 160 based on information stored in the memory 120.

The memory 120 may store natural real images taken while driving a real bike, and distance information and altitude information that are measured simultaneously with shooting of the natural real images to be synchronized with the natural real images. The memory 120 may store road surface state information obtained by measuring a vibration of the bike by using an acceleration sensor, a gyro sensor, a vibration sensor, and the like when shooting a natural image. The memory 120 may store contents such as text, images, sounds, and videos in various formats. The natural real image may be content in the form of a video. The memory 120 may store subscriber information. Meanwhile, the memory 120 may receive a natural real image, distance information and altitude information, road surface condition information, content, subscriber information, and the like from a server 200 to store them. The natural real image, the distance information and the altitude information, the road surface condition information, the content, etc. may be streamed in real time from the server 200.

The road slope implementation unit 130 may attenuate a movement of the wheel 101 depending on a road slope calculated from the distance information and the altitude information so that a user can feel the road slope. That is, the road slope implementation unit 130 may adjust strength of a load that attenuates the movement of the wheel 101 in proportion to the increasing road slope. The road slope implementation unit may include a magnet driver 131 and a magnet unit 132.

The road surface condition implementation unit 140 changes a phase of the saddle 105 based on a road surface condition so that the user can feel bumpiness depending on the road surface condition. That is, the road surface condition implementation unit 140 may change the phase of the saddle 105 depending on a road surface condition based on vibrations that are measured simultaneously with shooting of natural real images to be synchronized with the natural real images. The road surface condition implementation unit 140 may include a motor driver 141, a motor 142, a pulley 143, and a shaft 144.

The content implementation unit 150 may adjust a reproduction state of natural real images, text, images, sounds, videos, etc. depending on user pedaling. For example, a speed of the wheel 101 depending on the user pedaling may be measured by the speed sensor 104, and the content implementation unit 150 may enable a user to feel as if the user is actually driving outdoors on a bike by adjusting a display speed of the natural real image in response to the speed of the wheel 101. The content implementation unit 150 may normally reproduce text, images, sounds, videos, etc. when the speed of the wheel 101 is equal to or greater than a predetermined threshold and may perform the reproduction by reducing the reproduced speed of the text and the images, and reducing a size of the sound and a brightness of the video when the speed of the wheel 101 is lower than the threshold. The content implementation unit 150 may access the Internet, Wi-Fi, etc., and may install and execute applications such as various portal sites and various content sites that a user can select depending on her or his taste on the Internet. The portal sites include Naver, Daum Kakao, MSN, BING, Lycos, Yahoo, Baidu, QQ, Sina, and YouQ, and a type and number of the portal sites are not limited. The content sites may include various types of sites that can service webtoons, web novels, e-books, webzines, and the like. The content implementation unit 150 enables a user to select and execute new content provided by various portal sites and various content sites during exercise. The content implementation unit 150 may include a content driver 151 and a display unit 152.

The subscriber authentication unit 160 measures a weight of the user and uses it as a password for subscriber authentication. That is, the subscriber authentication unit 160 may measure the weight of the user in registering as a subscriber to store it as subscriber authentication information, and when the user sits on the saddle 105 later, may measure the weight of the user to authenticate the subscriber based on whether the weight of the user matches the stored subscriber authentication information. In this case, the subscriber authentication unit 160 may authenticate the subscriber when the weight of the user falls within a predetermined error range in the stored subscriber authentication information. The subscriber authenticator may include a scale sensor attached to the saddle 105.

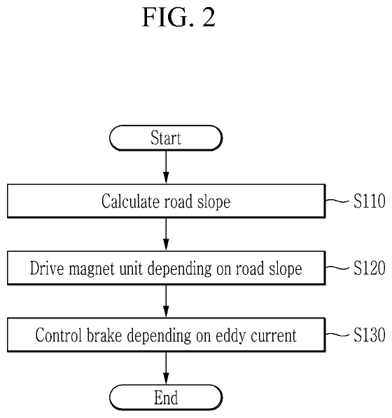

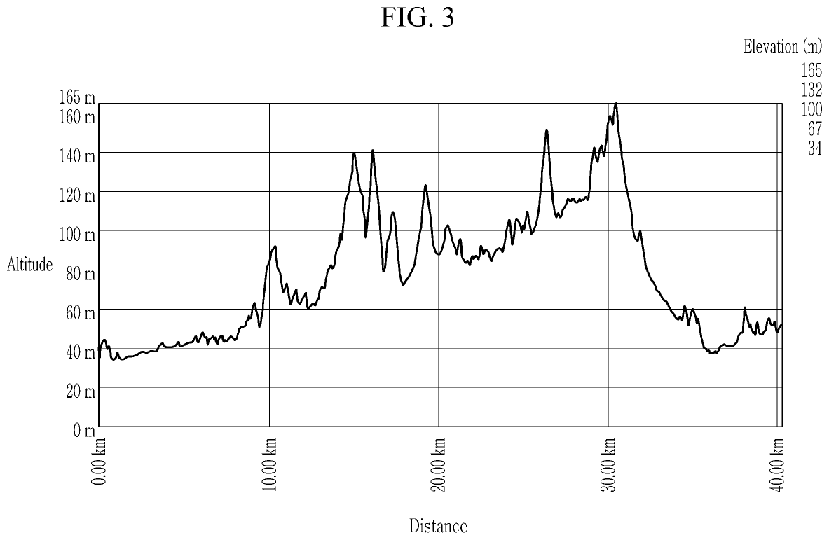

Hereinafter, the road slope implementation unit 130 will be described in more detail with reference to FIG. 2 and FIG. 3 along with FIG. 1.

FIG. 2 illustrates a flowchart showing a driving method for a moving bike device according to an embodiment of the present invention. FIG. 3 illustrates an example of a road slope stored in a memory of a moving bike device according to an embodiment of the present invention.

Referring to FIG. 2 and FIG. 3, the controller 110 calculates a road slope from the distance information and the altitude information that are measured simultaneously with the shooting of the natural real images to be synchronized with the natural real images (S110). As illustrated in FIG. 3, the controller 110 may calculate a graph of an altitude with respect to a distance (i.e., road slope) based on distance information and altitude information measured when shooting a natural real image, and may calculate the road slope corresponding to a travel distance depending on pedaling of a user. The controller 110 may calculate the travel distance depending on the pedaling by using a speed of the wheel 101 measured using the speed sensor 104. In this case, the controller 110 may transfer the speed of the wheel 101 depending on the pedaling of the user to the content driver 151, and the content driver 151 may display the natural real image on the display unit 152 at a speed corresponding to the speed of the wheel 101.

The controller 110 transfers the road slope corresponding to the travel distance to the magnet driver 131, and the magnet driver 131 drives the magnet unit 132 depending on the road slope (S120). The magnet driver 131 may move the magnet unit 132 such that the magnet unit 132 approaches the wheel 101 in proportion to the increasing road slope. In this case, the magnet unit 132 may include a permanent magnet. That is, when the road slope is gentle, the magnet unit 132 moves away from the wheel 101, and when the road slope is steep, the magnet unit 132 moves closer to the wheel 101. As the magnet unit 132 is positioned adjacent to the wheel 101, an eddy current is generated in the rotating wheel 101. A magnitude of the eddy current increases as a position of the magnet unit 132 is closer to the wheel 101, and decreases as the position of the magnet unit 132 moves away from the wheel 101. That is, a magnitude of the eddy current increases in proportion to the road slope.

A brake of the wheel 101 is controlled depending on the eddy current (S130). That is, the road slope implementation unit 130, which is an eddy current brake, may adjust a pedaling load by attenuating a movement of the wheel 101 in proportion to the magnitude of the eddy current. When the magnitude of the eddy current increases, strength of the eddy current brake increases, increasing the pedaling load, while when the magnitude of the eddy current decreases, the strength of the eddy current brake decreases, decreasing the pedaling load. In other words, the strength of the eddy current brake may be adjusted in proportion to the road slope.

Meanwhile, the controller 110 may control the road slope implementation unit 130 such that the strength of the eddy current brake is adjusted when the road slope is 0 for the decreasing road slope, or may control the road slope implementation unit 130 such that the strength of the eddy current brake is adjusted to be weaker than when the road surface slope is zero.

As such, a user can feel the road slope as if the user is actually driving on a real bike by automatically adjusting a pedaling load of the user depending on the road slope corresponding to the natural real image.

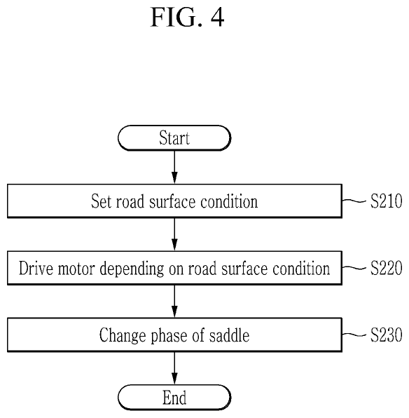

Hereinafter, the road surface condition implementation unit 140 will be described in more detail with reference to FIG. 4 together with FIG. 1.

FIG. 4 illustrates a flowchart showing a driving method for a moving bike device according to another embodiment of the present invention.

Referring to FIG. 4, the controller 110 sets a road surface condition based on vibrations that are measured simultaneously with shooting of natural real images to be synchronized with the natural real images (S210). The vibrations of the bike may be measured by using an acceleration sensor, a gyro sensor, a vibration sensor, etc., and vibration information of the bike may be stored in the memory 120. Alternatively, the vibration information of the bike may be streamed from the server 200. The controller 110 may set a road surface condition including a magnitude and a cycle of vibrations for each travel position depending on pedaling of the user based on the vibration information stored in the memory 120 or the vibration information streamed from the server 200. Even in this case, the controller 110 may transfer the speed of the wheel 101 depending on the pedaling of the user to the content driver 151, and the content driver 151 may display the natural real image on the display unit 152 at a speed corresponding to the speed of the wheel 101.

The controller 110 transfers the road surface condition to the motor driver 141, and the motor driver 141 drives the motor 142 depending on the road surface condition (S220). The motor driver 141 may control a rotation direction and a rotation speed of the motor 142 depending on the road surface condition. The motor 142 moves the pulley 143 in a forward or backward direction depending on control of the motor driver 141. Although one pulley 143 is illustrated in FIG. 1, one or more pulleys are further included between the motor 142 and the pulley 143 so that a ratio of the rotational speed of the motor 142 and the rotational speed of the pulley 143 may be adjusted.

The shaft 144 connected between the pulley 143 and the saddle 105 changes a phase of the saddle 105 depending on a movement of the pulley 143 (S230). That is, as the phase of the saddle 105 fluctuates up and down depending on the road surface condition, the actual road surface condition may be implemented by vibrations of the saddle 105.

As such, the user can feel the road surface condition as if riding a real bike as the actual road surface condition is expressed as vibration of the saddle 105 by allowing the phase of the saddle 105 to be changed depending on the road surface condition corresponding to the natural real image.

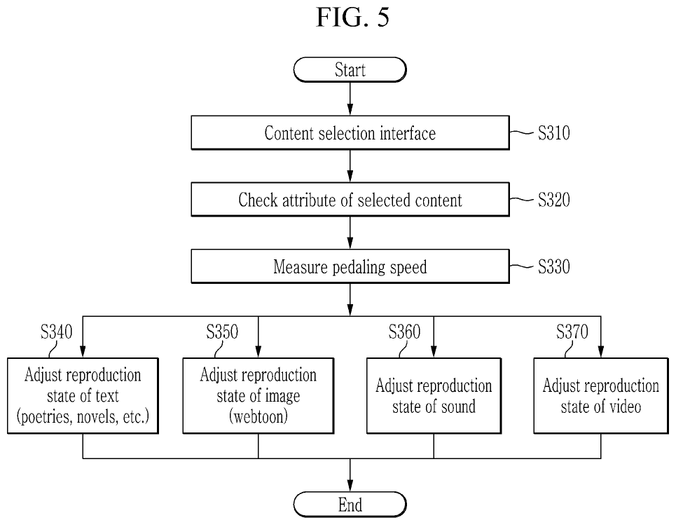

Hereinafter, the content implementation unit 150 will be described in more detail with reference to FIG. 5 together with FIG. 1.

FIG. 5 illustrates a flowchart showing a driving method for a moving bike device according to yet another embodiment of the present invention.

Referring to FIG. 5, the content driver 151 displays a content selection interface on the display unit 152 depending on a start of use of the moving bike device 100 or a user request (S310). The content selection interface is a screen where various types of text, images, sounds, videos, etc. can be selected. The text may include contents such as poetry, novels, sayings, and liberal arts books. The images may include photos, famous paintings, cartoons, webtoons, advertisements, and the like. The sound may include music, songs, voices, natural sounds, and the like. The videos may include natural real images, movies, advertisement images, and the like. A user may select one or more contents in the content selection interface. In addition, the content selection interface may be displayed on the display unit 152 in the form of an icon during content reproduction, and the user may change or add content to be reproduced during reproduction of the content. In addition, the content driver 151 may provide an application for accessing various portal sites and various content sites through wired or wireless Internet to the content selection interface, and a user may select new content provided by various portal sites and various content sites through the content selection interface.

The content driver 151 checks an attribute of each of the one or more selected contents (S320). That is, the content driver 151 checks to which type of text, images, sounds, or videos the selected content belongs.

The controller 110 measures a pedaling speed of the user (S330). The controller 110 may measure the pedaling speed of the user by measuring a speed of the wheel 101 through the speed sensor 104. The control unit 110 transfers the measured speed of the wheel 101 to the content driver 151.

The memory 120 may store various types of content, such as text, images, sounds, and videos, or various types of content such as text, images, sounds, and videos may be streamed from the server 200, and the controller 110 may transmit one or more contents among the text, the images, the sounds, and the videos to the content driver 151 depending on user selection to reproduce the content on the display unit 152.

For example, when a user selects text after selecting a natural real image, the natural real image and the text may be reproduced together. When the user selects a sound after selecting the natural real image, the natural real image and the sound may be reproduced together. In this case, when the natural real image is reproduced, the above-described road slope implementation unit 130 and the road surface condition implementation unit 140 may operate. The user may also select an image, a sound, and text, and the image, the sound, and the text may be reproduced together. In addition, various contents may be reproduced in various combinations.

The content driver 151 may adjust a content reproduction state as in steps S340, S350, S360, and S370 depending on a content attribute and a speed of the wheel 101 transferred from the controller 110, i.e., a pedaling speed of the user.

When the content corresponds to the text, the content driver 151 may adjust a reproduction state of the text in response to the speed of the wheel 101 (pedaling speed of the user) (S340). The text may be displayed on the display unit 152 in a scrolling manner. When the speed of the wheel 101 (pedaling speed of the user) is greater than or equal to a predetermined threshold, the content driver 151 may reproduce the text such that the text is scrolled in a normal state in which readability of the text is the best, when the speed of the wheel 101 (pedaling speed of the user) is lower than the threshold, may reproduce the text such that the text is scrolled slower than the normal state, and when the speed of the wheel 101 (pedaling speed of the user) is lower than a lowest setting value, may reproduce the text such that the text is not scrolled and stops. That is, the content driver 151 may adjust a reproduction speed of the text in response to the pedaling speed of the user.

When the content corresponds to the image, the content driver 151 may adjust a reproduction state of the image in response to the speed of the wheel 101 (pedaling speed of the user) (S350). The image may be displayed on the display unit 152 in a manner in which a plurality of still images are changed at a certain cycle or in a scrolling manner such as a webtoon. When the speed of the wheel 101 (pedaling speed of the user) is greater than or equal to a predetermined threshold, the content driver 151 may perform reproduction in a normal state of changing the still images at a regular interval or scrolling the image (webtoon) at a speed with best readability. When the speed of the wheel 101 (pedaling speed of the user) is lower than the threshold, the content driver 151 may perform reproduction in a state of changing the still images at an interval that is longer than the regular interval or scrolling the image (webtoon) slower than the normal state. When the speed of the wheel 101 (pedaling speed of the user) is lower than a lowest setting value, the content driver 151 may perform reproduction such that the image is stopped without being changed or scrolled. That is, the content driver 151 may adjust a reproduction speed of the image in response to the pedaling speed of the user.

When the content is the sound, the content driver 151 may adjust a reproduction state of the sound in response to the speed of the wheel 101 (pedaling speed of the user) (S360). When a reproduction speed of the wheel 101 is slowed corresponding to the speed of the wheel 101 (pedaling speed of the user) during reproduction of a sound type of content, the sound is distorted, and thus the content driver 151 maintains a reproduction speed of the sound at a constant speed. When the speed of the wheel 101 (pedaling speed of the user) is greater than or equal to a predetermined threshold, the content driver 151 may reproduce the sound in a normal volume, when the speed of the wheel 101 (pedaling speed of the user) is lower than the threshold, may reproduce the sound in a volume that is lower than the normal volume by gradually turning the volume of the sound down, and when the speed of the wheel 101 (pedaling speed of the user) is lower than a lowest setting value, may stop reproducing the sound. That is, the content driver 151 may adjust the volume of the sound in response to the pedaling speed of the user.

When the content corresponds to the video, the content driver 151 may adjust a reproduction state of the video in response to the speed of the wheel 101 (pedaling speed of the user) (S370). Since a video-type of content includes a moving image and a sound, distortion of the sound occurs when a reproduction speed of the video is changed, and thus the content driver 151 maintains the reproduction speed of the video at a constant speed while the video is reproduced. When the speed of the wheel 101 (pedaling speed of the user) is greater than or equal to a predetermined threshold, the content driver 151 may perform reproduction in a normal state of having screen brightness or resolution of the video as original quality, when the speed of the wheel 101 (pedaling speed of the user) is lower than the threshold, may perform reproduction by progressively reducing the screen brightness or resolution of the video to be lower than the normal state, and when the speed of the wheel 101 (pedaling speed of the user) is lower than a lowest setting value, may stop reproducing the video. That is, the content driving unit 151 may maintain the reproduction speed of the video at a constant speed, and may adjust the screen brightness or resolution of the video in response to the pedaling speed of the user.

A process of adjusting the reproduction state of the text (S340), a process of adjusting the reproduction state of the image (S350), a process of adjusting the reproduction state of the sound (S360), and a process of adjusting the reproduction state of the video (S370) may be performed independently and simultaneously in response to the pedaling speed of the user.

In general, it is difficult for aerobic exercise to exceed 30 minutes, and while content is usually viewed or played on a smartphone, the moving bike device 100 according to an embodiment of the present invention may induce a user to exercise continuously and motivate the user to exercise without being bored by allowing the content to be scrolled or screen-transitioned through user pedaling. In addition, the moving bike device 100 according to an embodiment of the present invention may provide new content provided on various portal sites and various content sites during exercise of the user, and as a result, a new content may be provided to the user every time rather than limited contents, and thus it allows the user to continue exercising without getting bored.

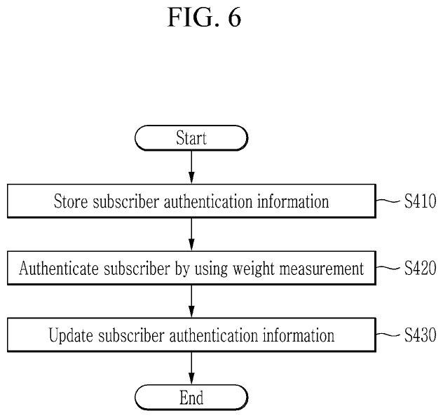

Hereinafter, the subscriber authentication unit 160 will be described in more detail with reference to FIG. 6 together with FIG. 1.

FIG. 6 illustrates a flowchart showing a driving method for a moving bike device according to yet another embodiment of the present invention.

Referring to FIG. 6, when the user sits on the saddle 105, a weight of the user is measured by a scale sensor. The controller 110 stores the weight of the user measured at the time of subscriber registration in the memory 120 as subscriber authentication information (S410). The weight of the user is used as a password for subscriber authentication.

Next, when the user sits on the saddle 105, the weight of the user is measured, the controller 110 compares a currently measured weight of the user with the subscriber authentication information stored in the memory 120, and authenticates the subscriber based on whether it falls within a predetermined error range (S420). The controller 110 may regard the user as a subscriber when the currently measured weight of the user falls within the error range (e.g., ±5%) based on the weight measured at the time of subscriber registration (member authentication information) in consideration of whether the weight of the subscriber changes over time or an error in measurement. A magnitude of the error range is not limited.

Then, the controller 110 updates the subscriber authentication information with the currently measured weight of the user (S430).

For example, when the weight of the user measured at the time of initial registration is 50 kg and the currently measured weight of the user is 51 kg, the currently measured weight of the user is between 47.5 kg and 52.5 kg with the error range of ±5%, so the user is authenticated as the subscriber. In addition, the currently measured user weight of 51 kg is updated as the subscriber authentication information, and when logging in later, the user having a weight within the error range of ±5% of 48.45 kg to 53.55 kg may be authenticated as the subscriber, based on the updated user weight of 51 kg.

While embodiments of the present invention have been particularly shown and described with reference to the accompanying drawings, the specific terms used herein are only for the purpose of describing the invention and are not intended to define the meanings thereof or be limiting of the scope of the invention set forth in the claims. Therefore, a person of ordinary skill in the art will understand that various modifications and other equivalent embodiments of the present invention are possible. Consequently, the true technical protective scope of the present invention must be determined based on the technical spirit of the appended claims.

### DESCRIPTION OF SYMBOLS

100: moving bike device 101: wheel
103: pedal 104: pedal
105: saddle 110: controller
120: memory 130: road slope implementation unit
131: magnet driver 132: magnet unit
140: road surface condition implementation unit
141: motor driver
142: motor 143: pulley
144: shaft 150: content implementation unit
151: content driver 152: display unit
160: subscriber authentication unit 200: server

What is claimed is:

1. A moving bike device comprising:
a memory configured to store distance information and altitude information;
a content implementation unit configured to adjust a reproduction state of content in response to a speed of a wheel depending on pedaling of a user;
a controller configured to calculate a road slope from the distance information and the altitude information, and to calculate a travel distance depending on the pedaling of the user; and
a road slope implementation unit configured to adjust strength of a brake in proportion to the road slope corresponding to the travel distance.

2. The moving bike device of claim 1, wherein
the road slope implementation unit includes:
a magnet unit configured to generate an eddy current in the wheel as it is positioned adjacent to the wheel; and
a magnet driver configured to move the magnet unit closer to the wheel in proportion to the road slope,
wherein the strength of the brake is adjusted in proportion to a magnitude of the eddy current.

3. The moving bike device of claim 1, wherein
the distance information and the altitude information are synchronized with a natural real image.

4. The moving bike device of claim 3, further comprising
a road surface condition implementation unit configured to change a phase of a saddle depending on a road surface condition based on a vibration that is synchronized to the natural real image.

5. The moving bike device of claim 4, wherein
the road surface condition implementation unit includes:
a shaft connected to the saddle;
a pulley connected to the shaft;
a motor configured to move the pulley in a forward or backward direction; and
a motor driver configured to drive the motor depending on the road surface condition.

6. The moving bike device of claim 1, further comprising
a subscriber authentication unit configured to measure a weight of the user and to use it as a password for subscriber authentication.

7. A moving bike device comprising:
a memory configured to store content of various attributes;
a content implementation unit configured to differently adjust a reproduction state of the content depending on an attribute of the content in response to a speed of a wheel according to pedaling of a user; and
a display unit configured to display the content,
wherein the content implementation unit adjusts a reproduction speed of text and images in response to the speed of the wheel depending on the pedaling of the user, adjusts a volume of a sound in response to the speed of the wheel depending on the pedaling of the user, and adjusts screen brightness or resolution of a video in response to the speed of the wheel depending on the pedaling of the user.

8. The moving bike device of claim 7, wherein
the content implementation unit
performs reproduction in a normal state of scrolling text when the speed of the wheel depending on the pedaling of the user is greater than or equal to a predetermined threshold,
performs reproduction such that the text is scrolled slower than the normal state when the speed of the wheel depending on the pedaling of the user is lower than the threshold, and
performs reproduction such that the text stops without being scrolled when the speed of the wheel depending on the pedaling of the user is lower than a lowest setting value.

9. The moving bike device of claim 7, wherein
the content implementation unit
performs reproduction in a normal state of changing an image or scrolling a webtoon when the speed of the wheel depending on the pedaling of the user is greater than or equal to a predetermined threshold,
performs reproduction such that the image is changed in an interval that is longer than the normal state or the webtoon scrolled slower than the normal state when the speed of the wheel depending on the pedaling of the user is lower than the threshold, and
performs reproduction such that the image is not changed or the webtoon stops without being scrolled when the speed of the wheel depending on the pedaling of the user is lower than a lowest setting value.

10. The moving bike device of claim 7, wherein
the content implementation unit
reproduces the sound at a normal volume level when the speed of the wheel depending on the pedaling of the user is greater than or equal to a predetermined threshold,
reproduces the sound by reducing the volume of the sound to be lower than the normal volume level when the speed of the wheel depending on the pedaling of the user is lower than the threshold, and
stops reproducing the sound when the speed of the wheel depending on the pedaling of the user is lower than a lowest setting value.

11. The moving bike device of claim 7, wherein
the content implementation unit
performs reproduction in a normal state of having screen brightness or resolution of the video as original quality when the speed of the wheel depending on the pedaling of the user is greater than or equal to a predetermined threshold,
performs reproduction by reducing the screen brightness or resolution of the video to be lower than the normal state when the speed of the wheel depending on the pedaling of the user is lower than the threshold, and
stops reproducing the video when the speed of the wheel depending on the pedaling of the user is lower than a lowest setting value.

12. The moving bike device of claim 7, wherein
the content implementation unit provides the user with content provided by a portal site and a content site by accessing the Internet.

13. The moving bike device of claim 7, further comprising
a road slope implementation unit configured to adjust strength of a brake by generating an eddy current in the wheel in proportion to a road slope corresponding to a travel distance depending on the pedaling of the user.

14. The moving bike device of claim 13, further comprising
a road surface condition implementation unit configured to change a phase of a saddle depending on a road surface condition based on a vibration that is synchronized to a natural real image.

15. A driving method for a moving bike device, comprising:
calculating a road slope from distance information and altitude information which are synchronized with a natural real image;
moving a magnet unit positioned adjacent to a wheel to be closer to the wheel in proportion to the road slope; and
controlling a brake depending on an eddy current generated in the wheel by the magnet unit.

16. The driving method of claim 15, further comprising
adjusting a display speed of the natural real image in response to a speed of the wheel depending on pedaling of a user.

17. The driving method of claim 15, further comprising:
setting a road surface condition based on a vibration synchronized to the natural real image;
moving a pulley in a forward or backward direction by driving a motor depending on the road surface condition; and
changing a phase of a saddle depending on a movement of the pulley.

18. A driving method for a moving bike device, comprising:
measuring a speed of a wheel depending on pedaling of a user; and
reproducing content including at least one of text, an image, a sound, or a video in a normal state when the speed of the wheel is equal to or greater than a predetermined threshold, and adjusting a reproduction state of the content when the speed of the wheel is lower than the threshold.

19. The driving method of claim 18, wherein,
when the speed of the wheel is lower than the threshold, reproduction is performed such that the content is scrolled slower than the normal state, reproduction is performed such that the image is changed in an interval that is longer than the normal state, the sound is produced in a volume that is lower than the normal volume, and reproduction is performed by reducing screen brightness or resolution of the video to be lower than the normal state.

20. The driving method of claim 18, wherein,
when the speed of the wheel is lower than a lowest setting value, reproduction is performed such that the text stops without being scrolled, reproduction is performed such that the image is stopped without being changed, reproduction is performed such that the sound stops being reproduced, and reproduction is performed such that the video stops being reproduced.

21. The driving method of claim 18, wherein
the user is provided with content provided by a portal site and a content site by accessing Internet driving method.

22. A driving method for a moving bike device, comprising:
measuring a weight of a user with a scale sensor and storing the weight of the user in a memory as subscriber authentication information when the user sits on a saddle;
authenticating the subscriber by comparing a currently measured weight of the user with the subscriber authentication information stored in the memory when the user sits on the saddle; and
updating the subscriber authentication information with the currently measured weight of the user.

23. The driving method of claim 22, wherein
the user is regarded as the subscriber when the currently measured weight of the user falls within an error range based on the subscriber authentication information.
